(19) United States
(12) Patent Application Publication
(10) Pub. No.: US 2023/0341834 A1
(43) Pub. Date: Oct. 26, 2023

(54) INFORMATION PROCESSING APPARATUS AND THREE-DIMENSIONAL SHAPING APPARATUS

(71) Applicant: SEIKO EPSON CORPORATION, Tokyo (JP)

(72) Inventor: Keitaro HASHIZUME, Shiojiri-shi (JP)

(21) Appl. No.: 18/305,524

(22) Filed: Apr. 24, 2023

(30) Foreign Application Priority Data
Apr. 26, 2022 (JP) 2022-072050

(51) Int. Cl. G05B 19/4099; B33Y 50/02

(52) U.S. Cl. CPC G05B 19/4099; B33Y 50/02; G05B 2219/49023

(57) ABSTRACT

An information processing apparatus includes: a storage unit configured to store object data indicating an object including at least a shaped body of the shaped body and a support body, the shaped body having a shape of a three-dimensional shaped object, the support body supporting the shaped body; and a generation unit configured to slice the object into a plurality of slice layers, generate a shaping path of the individual slice layers of the plurality of slice layers obtained by the slicing, and generate three-dimensional shaping data including shaping path information indicating the generated shaping path of the individual slice layers of the plurality of slice layers. When generating a shaping path of a second slice layer, the generation unit generates the shaping path of the second slice layer based on a type of a first slice layer and a type of the second slice layer.

The present application is based on, and claims priority from JP Application Serial Number 2022-072050, filed Apr. 26, 2022, the disclosure of which is hereby incorporated by reference herein in its entirety.

### BACKGROUND

### 1. Technical Field

The present disclosure relates to an information processing apparatus and a three-dimensional shaping apparatus.

### 2. Related Art

Research and development have been conducted on a three-dimensional shaping apparatus that shapes a three-dimensional shaped object by stacking a shaping material at least partially melted.

In this regard, as the three-dimensional shaping apparatus that shapes the three-dimensional shaped object by stacking the shaping material including a metal material, there is known a three-dimensional shaping apparatus that includes a stage on which the shaping material is to be stacked, in which a raft layer is stacked on the stage, and that forms a shaped body and a support body on the raft layer (see JP-T-2019-522105).

In the three-dimensional shaping apparatus as disclosed in JP-T-2019-522105, an interface layer formed of a material that is difficult to be bonded to the shaped body by sintering is formed at an interface between each of the raft layer, the support body, and the shaped body. Accordingly, in the three-dimensional shaping apparatus, after the shaping material is sintered, the raft layer and the support body can be easily removed from the shaped body. Here, easily removing the raft layer and the support body from the shaped body is required also in the shaping of the three-dimensional shaped object by stacking a resin material. However, a method using such an interface layer requires a sintering step of sintering the shaping material. On the other hand, the shaping of the three-dimensional shaped object by stacking the resin material does not include the sintering step. Therefore, it is difficult to easily remove the raft layer or the support body from the three-dimensional shaped object by applying the method to the shaping of the three-dimensional shaped object by stacking the resin material.

### SUMMARY

According to an aspect of the present disclosure, there is provided an information processing apparatus that generates three-dimensional shaping data for causing a plurality of slice layers to be stacked as a three-dimensional shaped object having a predetermined shape in a three-dimensional shaping apparatus. The information processing apparatus includes: a storage unit configured to store object data indicating an object including at least a shaped body of the shaped body and a support body, the shaped body having the shape of the three-dimensional shaped object, the support body supporting the shaped body; and a generation unit configured to virtually slice, based on slice condition information indicating a slice condition for virtually slicing the object indicated by the object data into the plurality of slice layers, the object into the plurality of slice layers, generate, based on shaping path generation condition information indicating a shaping path generation condition for generating a shaping path of the plurality of slice layers individually, the shaping path of the individual slice layers of the plurality of slice layers obtained by the slicing, and generate the three-dimensional shaping data including shaping path information indicating the generated shaping path of the individual slice layers of the plurality of slice layers. The slice condition information includes first slice layer type information indicating a type of a first slice layer among the plurality of slice layers and second slice layer type information indicating a type of a second slice layer stacked on the first slice layer among the plurality of slice layers. The shaping path generation condition information includes correspondence information including information in which the type of the first slice layer, the type of the second slice layer, and information indicating a condition for generating a shaping path of the second slice layer are associated with one another. When generating the shaping path of the second slice layer, the generation unit generates the shaping path of the second slice layer based on the correspondence information, the type of the first slice layer, and the type of the second slice layer.

According to another aspect of the present disclosure, there is provided a three-dimensional shaping apparatus including an information processing apparatus configured to generate three-dimensional shaping data for causing a plurality of slice layers to be stacked as a three-dimensional shaped object having a predetermined shape in the three-dimensional shaping apparatus. The information processing apparatus includes: a storage unit configured to store object data indicating an object including at least a shaped body of the shaped body and a support body, the shaped body having the shape of the three-dimensional shaped object, the support body supporting the shaped body; and a generation unit configured to virtually slice, based on slice condition information indicating a slice condition for virtually slicing the object indicated by the object data into the plurality of slice layers, the object into the plurality of slice layers, generate, based on shaping path generation condition information indicating a shaping path generation condition for generating a shaping path of the plurality of slice layers individually, the shaping path of the individual slice layers of the plurality of slice layers obtained by the slicing, and generate the three-dimensional shaping data including shaping path information indicating the generated shaping path of the individual slice layers of the plurality of slice layers. The slice condition information includes first slice layer type information indicating a type of a first slice layer among the plurality of slice layers and second slice layer type information indicating a type of a second slice layer stacked on the first slice layer among the plurality of slice layers. The shaping path generation condition information includes correspondence information including information in which the type of the first slice layer, the type of the second slice layer, and information indicating a condition for generating a shaping path of the second slice layer are associated with one another. When generating the shaping path of the second slice layer, the generation unit generates the shaping path of the second slice layer based on the correspondence information, the type of the first slice layer, and the type of the second slice layer.

### BRIEF DESCRIPTION OF THE DRAWINGS

FIG. 1 is a view showing an example of a configuration of a three-dimensional shaping apparatus 1.

FIG. 2 is a diagram showing an example of a hardware configuration of a data generation device 50.

FIG. 3 is a diagram showing an example of a functional configuration of the data generation device 50.

FIG. 4 is a diagram showing an example of a flow of processing in which the data generation device 50 generates three-dimensional shaping data.

FIG. 5 is a view showing an example of a contact area between a first slice layer LL1 and a second slice layer LL2 when a shaping path P1 of the first slice layer LL1 and a shaping path P2 of the second slice layer LL2 stacked on the first slice layer LL1 completely overlap with each other in a vertical direction.

FIG. 6 is a view showing an example of a cross-sectional view when the first slice layer LL1 and the second slice layer LL2 are cut along a line A-A′ shown in FIG. 5.

FIG. 7 is a view showing an example of a contact area between a certain first slice layer LL3 and a certain second slice layer LL4 when a shaping path P3 of the first slice layer LL3 and a shaping path P4 of the second slice layer LL4 stacked on the first slice layer LL3 do not substantially overlap with each other in the vertical direction.

FIG. 8 is a view showing an example of a cross-sectional view when the first slice layer LL3 and the second slice layer LL4 are cut along a line B-B′ shown in FIG. 7.

FIG. 9 is a diagram showing an example of a flow of processing in which a control device 40 causes the three-dimensional shaping apparatus 1 to shape a three-dimensional shaped object.

### DESCRIPTION OF EXEMPLARY EMBODIMENTS

### Embodiment

Hereinafter, an embodiment according to the present disclosure will be described with reference to the drawings.

### Outline of Three-Dimensional Shaping Apparatus

First, an outline of a three-dimensional shaping apparatus according to an embodiment will be described.

The three-dimensional shaping apparatus according to the embodiment includes an information processing apparatus that generates three-dimensional shaping data for causing the three-dimensional shaping apparatus to stack a plurality of slice layers as a three-dimensional shaped object having a predetermined shape. The information processing apparatus includes a storage unit and a generation unit. The storage unit stores object data indicating an object including at least a shaped body of the shaped body and a support body, the shaped body has a shape of the three-dimensional shaped object, and the support body supports the shaped body. The generation unit virtually slices, based on slice condition information indicating a slice condition for virtually slicing the object indicated by the object data into the plurality of slice layers, the object into the plurality of slice layers, generates, based on shaping path generation condition information indicating a shaping path generation condition for generating a shaping path of the plurality of slice layers individually, the shaping path of the individual slice layers of the plurality of slice layers obtained by the slicing, and generates three-dimensional shaping data including shaping path information indicating the generated shaping path of the individual slice layers of the plurality of slice layers. Accordingly, the three-dimensional shaping apparatus can generate the three-dimensional shaping data for easily removing the raft layer and the support body from the shaped body without a sintering step.

Hereinafter, a configuration of the three-dimensional shaping apparatus according to the embodiment, a configuration of the information processing apparatus included in the three-dimensional shaping apparatus, and processing performed by the information processing apparatus will be described in detail.

### Configuration of Three-dimensional Shaping Apparatus

Hereinafter, the configuration of the three-dimensional shaping apparatus according to the embodiment will be described by taking a three-dimensional shaping apparatus 1 as an example.

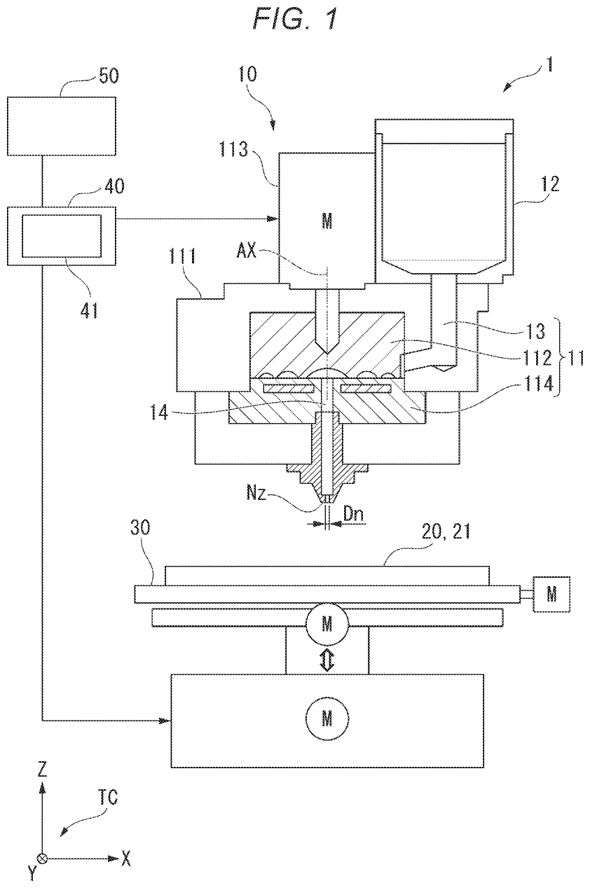

FIG. 1 is a view showing an example of a configuration of the three-dimensional shaping apparatus 1.

Here, a three-dimensional coordinate system TC is a three-dimensional orthogonal coordinate system indicating directions in a drawing in which the three-dimensional coordinate system TC is drawn.

Hereinafter, for convenience of description, an X axis in the three-dimensional coordinate system TC will be simply referred to as an X axis. Hereinafter, for convenience of description, a Y axis in the three-dimensional coordinate system TC is simply referred to as a Y axis. Hereinafter, for convenience of description, a Z axis in the three-dimensional coordinate system TC is simply referred to as a Z axis. Hereinafter, for example, a case where a negative direction of the Z axis coincides with a gravity direction will be described. Therefore, hereinafter, for convenience of description, a positive direction of the Z axis is referred to as an upward direction or simply as up, and the negative direction of the Z axis is referred to as a downward direction or simply as down.

The three-dimensional shaping apparatus 1 includes a discharge unit 10 including a nozzle Nz, a stage 20 having a shaping surface 21 on which the three-dimensional shaped object is to be shaped, a moving unit 30, a control device 40, and a data generation device 50. In the three-dimensional shaping apparatus 1, the data generation device 50 may be integrated with the control device 40. Further, the three-dimensional shaping apparatus 1 may not include the data generation device 50. In this case, the data generation device 50 is communicably coupled to the three-dimensional shaping apparatus 1 from an outside. Further, the three-dimensional shaping apparatus 1 may not include the control device 40 and the data generation device 50. In this case, the data generation device 50 is communicably coupled to the three-dimensional shaping apparatus 1 via the control device 40.

The three-dimensional shaping apparatus 1 changes a relative position between the discharge unit 10 and the stage 20 while discharging a shaping material X (not shown) from the discharge unit 10 toward the shaping surface 21 of the stage 20. Accordingly, the three-dimensional shaping apparatus 1 shapes one three-dimensional shaped object having a predetermined shape by stacking N slice layers. Here, N may be any integer as long as it is an integer of 1 or more. In this case, a first slice layer counted from a bottom among the N slice layers is stacked on the shaping surface 21. Each of the N slice layers stacked on the shaping surface 21 is the shaping material X discharged along a shaping path thereof parallel to the shaping surface 21. The shaping path is a traversal path of the nozzle Nz moving while discharging the shaping material X with respect to the stage 20. That is, the three-dimensional shaping apparatus 1 discharges the shaping material X along a shaping path of an n-th slice layer among the N slice layers by the discharge unit 10, and stacks the n-th slice layer on an (n-1)-th slice layer. Each of the N slice layers may include a single layer or may include a plurality of stacked layers. Here, n is an integer of 1 or more and N or less. A shaping path of a certain slice layer includes an outline that is a traversal path of the nozzle Nz along a contour of the slice layer, and an infill that is a traversal path of the nozzle Nz in a region surrounded by the outline. That is, a certain slice layer includes the shaping material X discharged along the outline of the slice layer and the shaping material X discharged along the infill of the slice layer.

The three-dimensional shaping apparatus 1 performs shaping of such a three-dimensional shaped object based on the three-dimensional shaping data. Here, the three-dimensional shaping apparatus 1 generates the three-dimensional shaping data according to a received operation. The three-dimensional shaping data is data for causing the three-dimensional shaping apparatus 1 to stack the N slice layers as the three-dimensional shaped object having the predetermined shape. The three-dimensional shaping apparatus 1 stores shape data indicating the shape. The shape data may be any shape data as long as the shape data is, for example, data indicating the shape, and is, for example, stereolithography (STL) data. Based on the received operation and the shape data, the three-dimensional shaping apparatus 1 generates the object data indicating a virtual object including at least a virtual shaped body of the virtual shaped body and a virtual support body, the virtual shaped body has a shape indicated by the shape data, and the virtual support body is added to the shaped body to support the shaped body. The shaped body is a portion that is separated from the N slice layers as one three-dimensional shaped object among portions included in the stacked N slice layers. Further, the support body is a portion that supports the shaped body among portions included in the stacked N slice layers.

After generating the object data, the three-dimensional shaping apparatus 1 stores the generated object data. After storing the object data, the three-dimensional shaping apparatus 1 virtually slices the object indicated by the stored object data into N layers based on slice condition information. Each of the N layers into which the object is virtually sliced by the three-dimensional shaping apparatus 1 in this manner corresponds to each of the N slice layers described above. Therefore, hereinafter, for convenience of description, an n-th layer among the N layers is referred to as a slice layer VLn, and the n-th slice layer among the N slice layers is referred to as a slice layer Ln. In this case, for example, a first slice layer VL1 corresponds to a first slice layer L1. Hereinafter, for convenience of description, the first slice layer VL1 to the N-th slice layer VLN are simply referred to as slice layers VL unless they need to be distinguished from each other. Hereinafter, for convenience of description, the first slice layer L1 to the N-th slice layer LN are simply referred to as slice layers L unless they need to be distinguished from each other. Here, the slice condition information is information indicating a slice condition for virtually slicing the object indicated by the object data stored in the three-dimensional shaping apparatus 1 into the N slice layers VL. The slice condition information includes information such as information indicating N, which is the number of N slice layers VL, and information indicating a thickness of each of the N slice layers VL.

After the object is virtually sliced, the three-dimensional shaping apparatus 1 generates a shaping path of the slice layer VL for each of the N slice layers VL obtained by slicing based on the shaping path generation condition information. The shaping path is the traversal path of the nozzle Nz moving while discharging the shaping material X with respect to the stage 20. Therefore, the shaping material X discharged along the shaping path of the n-th slice layer VLn is the actual slice layer Ln corresponding to the slice layer VLn.

Here, the n-th slice layer VLn is one of the slice layers obtained by slicing at least one of the shaped body and the support body included in the object. Therefore, the n-th slice layer VLn includes at least one of a portion obtained by slicing the shaped body and a portion obtained by slicing the support body. That is, the n-th slice layer VLn includes at least one of a layer obtained by slicing the shaped body and a layer obtained by slicing the support body. The layer obtained by slicing the shaped body is classified into two types including a first solid layer and a shaping layer. The first solid layer is a solid layer of the shaped body. The shaped body includes first solid layers and a shaping layer stacked between the first solid layer and the first solid layer. That is, the shaped body is shaped by stacking the first solid layers and the shaping layer. Further, the layer obtained by slicing the support body is classified into three types including a second solid layer, a support layer, and a raft layer. The second solid layer is a solid layer of the support body. The raft layer is a layer serving as a base on which the first solid layer, the shaping layer, the second solid layer, and the support layer are stacked. The support body includes the second solid layers, the support layer stacked between the second solid layer and the second solid layer, and the raft layer. That is, the support body is shaped by stacking the second solid layers, the support layers, and the raft layer. For example, when a shape of a certain shaped body has an overhang, a portion of overhang among portions of the shaped body is supported by such a support body. As described above, types of the n-th slice layer VLn are classified by layers included in the n-th slice layer VLn. For example, when the n-th slice layer VLn includes only the first solid layer, the type of the n-th slice layer VLn is the first solid layer. Further, for example, when the n-th slice layer VLn includes the first solid layer and the second solid layer, the type of the n-th slice layer VLn is represented by a combination of a type of the layer obtained by slicing the shaped body among the layers included in the n-th slice layer VLn and a type of the layer obtained by slicing the support body among the layers included in the n-th slice layer VLn, that is, a combination of the first solid layer and the second solid layer. The type of the n-th slice layer VLn is also a type of the n-th slice layer Ln. Therefore, the three-dimensional shaping apparatus 1 can specify, based on the slice condition information, the type of the n-th slice layer VLn, and can specify the type of the slice layer Ln.

After generating the shaping path of the slice layer VL for each of the N slice layers VL based on the shaping path generation condition information, the three-dimensional shaping apparatus 1 generates the three-dimensional shaping data including shaping path information indicating the generated shaping path of each of the N slice layers VL. Here, the shaping path generation condition information is information indicating a shaping path generation condition for generating the shaping path for each of the N slice layers VL. The shaping path generation condition information includes information such as information indicating a shape of the shaping path for each type of the N slice layers VL, information indicating a width of the shaping path for each type of the N slice layers VL, and information indicating a moving speed of the nozzle Nz when the shaping material X is discharged along the shaping path for each type of the N slice layers VL. In addition, the shaping path information indicating a certain shaping path includes other information such as information indicating a width of the shaping path and information indicating a moving speed of the nozzle Nz when the shaping material X is discharged along the shaping path.

In the three-dimensional shaping apparatus 1, the slice condition information includes (n-1)-th slice layer type information indicating a type of an (n-1)-th slice layer VLn-1 among the N slice layers VL and n-th slice layer type information indicating the type of n-th slice layer VLn stacked on the (n-1)-th slice layer VLn-1 among the N slice layers VL. In the three-dimensional shaping apparatus 1, the shaping path generation condition information includes correspondence information including information in which the type of the (n-1)-th slice layer VLn-1, the type of the n-th slice layer VLn, and information indicating a condition for generating the shaping path of the n-th slice layer VLn are associated with one another. When generating the shaping path of the n-th slice layer VLn, the three-dimensional shaping apparatus 1 generates the shaping path of the n-th slice layer VLn based on the correspondence information, the type of the (n-1)-th slice layer VLn-1, and the type of the n-th slice layer VLn. Accordingly, the three-dimensional shaping apparatus 1 can generate the three-dimensional shaping data for easily removing the raft layer and the support body from the shaped body without a sintering step.

Here, the slice layer L serving as the raft layer among N slice layers L is a layer, as a base of the slice layers L of another layer, formed between the shaping surface 21 and another layer, and is a layer filled with the shaping material X. Another layer is an individual slice layer L stacked on the raft layer among the N slice layers L, and specifically, is a slice layer L of a part or all of the first solid layer, the shaping layer, the second solid layer, and the support layer. When another layer is stacked on the shaping surface 21 to be in contact with the shaping surface 21, another layer may not be easily peeled off from the shaping surface 21. In this case, another layer may not be accurately fixed. In addition, in this case, residual stress may remain in another layer. To solve these problems, a layer stacked between another layer and the shaping surface 21 is the slice layer L of the raft layer. Each of the slice layers L serving as the solid layer, the shaping layer, and the support layer is formed by the outline which is the shaping material X discharged along a contour of a predetermined outer shape, and the infill which is the shaping material X discharged into a region surrounded by the outline. The slice layer L serving as the solid layer is a layer in which an inside of a region surrounded by the outline of the slice layer L of the solid layer is filled with the infill substantially with no gap. In other words, the slice layer L serving as the solid layer is a layer in which a filling rate of the infill in the region is 100%. The slice layer L serving as the first solid layer can be rephrased as one or more layers including the shaping material X forming a surface of the shaped body. The slice layer L serving as the shaping layer is one or more layers including the shaping material X forming an inside of the shaped body. The slice layer L serving as the second solid layer can be rephrased as one or more layers including the shaping material X forming a surface of the support body. On the other hand, the slice layer L serving as the shaping layer is a layer in which the infill is included in the region surrounded by the outline of the shaping layer, and in which a region not filled with the infill is present in the region. In other words, the slice layer L serving as the shaping layer is a layer in which the filling rate of the infill in the region is less than 100%. The slice layer L serving as the shaping layer can be rephrased as one or more layers including the shaping material X forming the inside of the shaped body. The slice layer L serving as the support layer is a layer in which the infill is included in the region surrounded by the outline of the support layer, and in which a region not filled with the infill is present in the region. In other words, the slice layer L serving as the support layer is a layer in which the filling rate of the infill in the region is less than 100%. Further, the slice layer L serving as the support layer can be rephrased as one or more layers including the shaping material X forming an inside of the support body.

When the three-dimensional shaping apparatus 1 stacks the N slice layers L on the shaping surface 21 based on the three-dimensional shaping data generated as described above, the three-dimensional shaping apparatus 1 discharges each of the N slice layers L onto the shaping surface 21 by the discharge unit 10 as the slice layers L of types represented by a part or all of the raft layer, the first solid layer, the shaping layer, the second solid layer, and the support layer, and stacks the N slice layers L to shape one three-dimensional shaped object. Accordingly, the three-dimensional shaping apparatus 1 can shape, as the three-dimensional shaped object, a shaped body from which the raft layer and the support body are easily removed without the sintering step. In other words, accordingly, the three-dimensional shaping apparatus 1 can shape, as the three-dimensional shaped object, the shaped body from which the raft layer and the support body are easily removed by stacking the shaping material X including a resin material.

The discharge unit 10 is a discharge device that discharges the shaping material X onto the shaping surface 21. More specifically, the discharge unit 10 includes, together with the nozzle Nz described above, a material melting unit 11 that melts one or more types of materials to form the shaping material X, and a material supply unit 12. Here, in the discharge unit 10, the material supply unit 12 and the material melting unit 11 are coupled to each other by a supply path 13. Further, the material melting unit 11 and the nozzle Nz are coupled with each other by a communication hole 14. Therefore, the nozzle Nz communicates with the material melting unit 11. The nozzle Nz discharges, from a tip end thereof, the shaping material X supplied from the material melting unit 11 through the communication hole 14.

Here, when stacking the n-th slice layer Ln on the (n-1)-th slice layer Ln-1, the three-dimensional shaping apparatus 1 changes a width of the shaping material X to be discharged onto an upper surface of the (n-1)-th slice layer Ln-1 by changing a distance between the upper surface of the (n-1)-th slice layer Ln-1 and the tip end of the nozzle Nz. A maximum value of the width of the shaping material X discharged onto the upper surface of the (n-1)-th slice layer Ln-1 by the three-dimensional shaping apparatus 1 is an outer diameter of the tip end of the nozzle Nz. This is because when the distance between the upper surface of the (n-1)-th slice layer Ln-1 and the tip end of the nozzle Nz is shorter than an inner diameter Dn of the tip end of the nozzle Nz, the shaping material X discharged from the tip end of the nozzle Nz is discharged onto the upper surface of the (n-1)-th slice layer while being crushed by the tip end of the nozzle Nz.

In the material supply unit 12, one or more kinds of materials in a state of pellets, powder, or the like are accommodated. Hereinafter, for example, a case where the material accommodated in the material supply unit 12 is a pellet-shaped acrylonitrile butadiene styrene (ABS) resin will be described. The material accommodated in the material supply unit 12 may be one or more kinds of other materials instead of the ABS resin. The material supply unit 12 is implemented by, for example, a hopper. The material accommodated in the material supply unit 12 is supplied to the material melting unit 11 through the supply path 13 provided below the material supply unit 12.

The material melting unit 11 includes a screw case 111, a flat screw 112 accommodated in the screw case 111, a driving motor 113 for driving the flat screw 112, and a barrel 114 fixed below the flat screw 112 in the screw case 111.

The flat screw 112 is a screw having a flat cylindrical shape, in which a spiral groove extending from an outer periphery of the cylinder toward a central axis AX of the cylinder is formed in a bottom surface of the cylinder.

The barrel 114 is provided with the communication hole 14. Further, a heater is incorporated in the barrel 114. A temperature of the heater is controlled by the control device 40.

At least a part of the material supplied between the rotating flat screw 112 and the barrel 114 is melted by the rotation of the flat screw 112 and heated by the heater incorporated in the barrel 114, and becomes the paste-shaped shaping material X having fluidity. The shaping material X is supplied to the nozzle Nz through the communication hole 14 provided in the barrel 114 by the rotation of the flat screw 112. Then, the shaping material X supplied to the nozzle Nz is discharged from the tip end of the nozzle Nz toward the stage 20.

The moving unit 30 changes the relative position between the nozzle Nz of the discharge unit 10 and the stage 20. More specifically, the moving unit 30 changes the relative position between the nozzle Nz of the discharge unit 10 and the stage 20 by moving one or both of the discharge unit 10 and the stage 20. Hereinafter, for example, a case where the moving unit 30 changes the relative position between the nozzle Nz of the discharge unit 10 and the stage 20 by moving the stage 20 will be described. For example, the moving unit 30 is implemented by a three-axis positioner that moves the stage 20 in directions parallel to the X axis, the Y axis, and the Z axis by driving forces of three motors. In this case, the three motors are controlled by the control device 40. Hereinafter, for convenience of description, a relative speed of the discharge unit 10 with respect to the stage 20 is simply referred to as a moving speed.

The control device 40 controls the entire three-dimensional shaping apparatus 1. The control device 40 acquires the three-dimensional shaping data generated by the data generation device 50 via a network or a recording medium. The control device 40 executes a three-dimensional shaping program stored in advance to perform shaping control for controlling operations of the discharge unit 10 and the moving unit 30 according to the three-dimensional shaping data, thereby shaping the three-dimensional shaped object. The control device 40 may be implemented not by a computer but by a combination of a plurality of circuits.

The shaping control is control of the discharge unit 10 and the moving unit 30. Specifically, the shaping control is control for shaping one three-dimensional shaped object having a predetermined shape by stacking the N slice layers L on the shaping surface 21. Here, the n-th slice layer Ln among the N slice layers L is stacked on the (n-1)-th slice layer Ln-1. At this time, when the n-th slice layer Ln is stacked on the (n-1)-th slice layer Ln-1, a part of the (n-1)-th slice layer Ln-1 is melted by heat of the n-th slice layer Ln. Therefore, the n-th slice layer Ln is joined to the (n-1)-th slice layer Ln-1. As a result, the N slice layers L are stacked as one three-dimensional shaped object on the shaping surface 21. Therefore, in the embodiment, a 0th slice layer L0 means the shaping surface 21. That is, in the embodiment, the first slice layer L1 is stacked on the 0th slice layer L0, that is, on the shaping surface 21.

When the n-th slice layer Ln is stacked on the (n-1)-th slice layer Ln-1, the control device 40 controls the discharge unit 10 and the moving unit 30 to discharge the shaping material X along the shaping path of the n-th slice layer VLn corresponding to the n-th slice layer Ln by the discharge unit 10. Accordingly, the control device 40 can stack the n-th slice layer Ln on the (n-1)-th slice layer Ln-1. By performing the control as described above as the shaping control, the control device 40 sequentially performs the discharge of the shaping material X, and shapes one three-dimensional shaped object by stacking the N slice layers L on the shaping surface 21.

Here, the control device 40 is implemented by a computer including one or more processors, a memory, and an input and output interface through which signals are inputs and output from and to an outside. The control device 40 includes a three-dimensional shaping apparatus control unit 41. The three-dimensional shaping apparatus control unit 41 acquires the three-dimensional shaping data generated by the data generation device 50, controls the three-dimensional shaping apparatus 1 based on the acquired three-dimensional shaping data, stacks the N slice layers L on the shaping surface 21 of the stage 20, and shapes one three-dimensional shaped object. The three-dimensional shaping apparatus control unit 41 is implemented by the processor included in the control device 40 executing the predetermined program stored in the memory. The program may be recorded in a non-transitory tangible recording medium readable by the computer.

The data generation device 50 is a device that generates the three-dimensional shaping data to be used by the three-dimensional shaping apparatus 1 to shape the three-dimensional shaped object. The data generation device 50 generates the three-dimensional shaping data by a method in which the three-dimensional shaping apparatus 1 described above generates the three-dimensional shaping data. Therefore, the description of the method is omitted here. Further, the data generation device 50 stores the shape data described above according to the received operation. The data generation device 50 may be capable of generating the shape data or may be incapable of generating the shape data. When the data generation device 50 is incapable of generating the shape data, the data generation device 50 acquires the shape data from another device via the network or the storage medium.

The data generation device 50 is, for example, an information processing apparatus such as a workstation, a desktop personal computer (PC), a notebook PC, a tablet PC, a multifunctional mobile phone terminal (smartphone), a mobile phone terminal, and a personal digital assistant (PDA), and is not limited thereto.

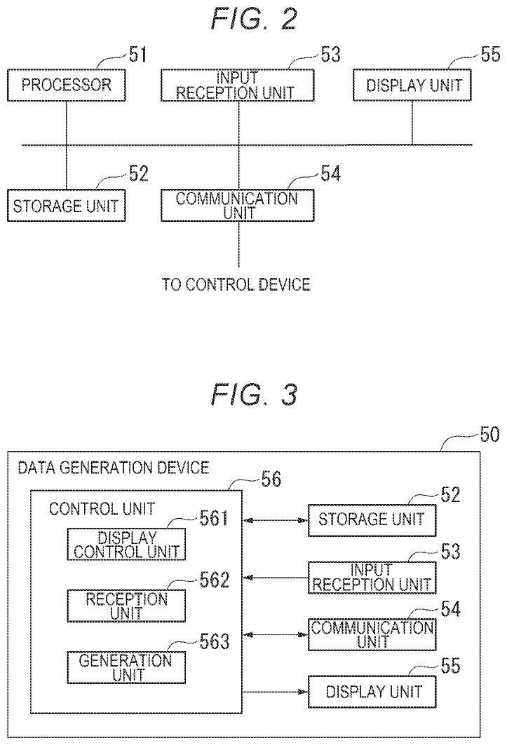

FIG. 2 is a diagram showing an example of a hardware configuration of the data generation device 50.

The data generation device 50 includes a processor 51, a storage unit 52, an input reception unit 53, a communication unit 54, and a display unit 55. As described above, the data generation device 50 may be an information processing apparatus implemented separately from the three-dimensional shaping apparatus 1. In this case, the three-dimensional shaping apparatus 1 is communicably coupled to the information processing apparatus via the control device 40, and is controlled by the information processing apparatus.

The processor 51 is, for example, a central processing unit (CPU). The processor 51 may be another processor such as a field programmable gate array (FPGA). The processor 51 may include a plurality of processors. The processor 51 implements various functions of the data generation device 50 by executing various programs, various commands, and the like stored in the storage unit 52.

The storage unit 52 includes a hard disk drive (HDD), a solid state drive (SSD), an electrically erasable programmable read only memory (EEPROM), a read only memory (ROM), a random access memory (RAM), and the like. The storage unit 52 may be an external storage device coupled by a digital input and output port such as a universal serial bus (USB) instead of being incorporated in the data generation device 50. The storage unit 52 stores various programs, various commands, various types of information, and the like to be processed by the data generation device 50. For example, the storage unit 52 stores the three-dimensional shaping data, the slice condition information, the shaping path generation condition information, the correspondence information, and the like.

The input reception unit 53 receives an operation performed by a user while viewing an image displayed on the display unit 55. The input reception unit 53 is, for example, an input device including a keyboard, a mouse, a touch pad, and the like. The input reception unit 53 may be a touch panel integrally formed with the display unit 55.

The communication unit 54 includes, for example, a digital input and output port such as a USB, and an Ethernet (registered trademark) port.

The display unit 55 displays the image. The display unit 55 is a display device including, for example, a liquid crystal display panel and an organic electroluminescence (EL) display panel as a display included in the data generation device 50.

FIG. 3 is a diagram showing an example of a functional configuration of the data generation device 50.

The data generation device 50 includes the storage unit 52, the input reception unit 53, the communication unit 54, the display unit 55, and a control unit 56.

The control unit 56 controls the entire data generation device 50. The control unit 56 includes a display control unit 561, a reception unit 562, and a generation unit 563. Functional units included in the control unit 56 are implemented by, for example, the processor 51 executing the various programs stored in the storage unit 52. A part or all of the functional units may be hardware functional units such as a large scale integration (LSI) and an application specific integrated circuit (ASIC).

The display control unit 561 generates various images to be displayed on the display unit 55 by the data generation device 50. The display control unit 561 displays the generated image on the display unit 55.

The reception unit 562 receives various types of information according to an operation received by the data generation device 50 via the input reception unit 53. The various types of information are, for example, the shape data, the slice condition information, the shaping path generation condition information, and the correspondence information described above.

The generation unit 563 generates the three-dimensional shaping data based on the shape data, the slice condition information, and the shaping path generation condition information which are received by the reception unit 562. The generation unit 563 causes the storage unit 52 to store the generated three-dimensional shaping data. Further, the generation unit 563 outputs the generated three-dimensional shaping data to another device such as the control device 40 via the communication unit 54.

### Processing of Generating Three-Dimensional Shaping Data by Data Generation Device

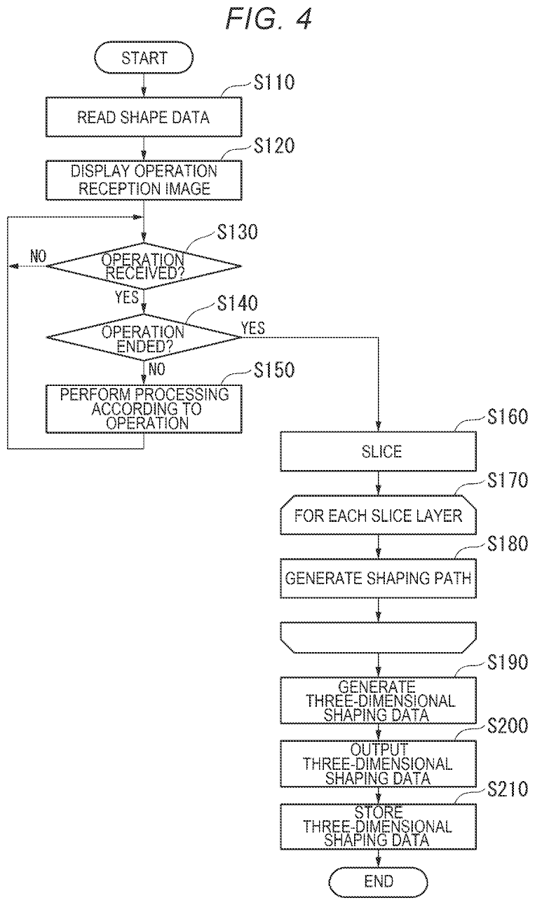

Hereinafter, processing in which the data generation device 50 generates the three-dimensional shaping data will be described with reference to FIG. 4. FIG. 4 is a diagram showing an example of a flow of the processing in which the data generation device 50 generates the three-dimensional shaping data. Hereinafter, for example, a case where the shape data is stored in the storage unit 52 at a timing before processing of step S110 shown in FIG. 4 is performed will be described. Further, hereinafter, for example, a case will be described where the data generation device 50 receives a data generation processing start operation of starting the generation of the three-dimensional shaping data based on the shape data stored in advance in the storage unit 52 at the timing.

After the data generation processing start operation is received, the display control unit 561 reads the shape data stored in advance in the storage unit 52 from the storage unit 52 (step S110).

Next, the display control unit 561 generates an operation reception image, and displays the generated operation reception image on the display unit 55 (step S120). Here, the operation reception image is an image for receiving an input of each of the slice condition information, the shaping path generation condition information, and the correspondence information to the data generation device 50. The operation reception image may be any image as long as the operation reception image is capable of receiving the input of each of the slice condition information, the shaping path generation condition information, and the correspondence information to the data generation device 50. For example, the operation reception image is an image including a graphical user interface (GUI) for receiving the input of each of the slice condition information, the shaping path generation condition information, and the correspondence information to the data generation device 50. Further, the operation reception image is an image for displaying a virtual shaped body having a shape indicated by the shape data read by the display control unit 561 from the storage unit 52 in step S110 and receiving editing of the displayed shaped body. The editing of the shaped body is, for example, addition of a virtual support body, and is not limited thereto. In addition, the operation reception image is an image for receiving an operation of generating the object data indicating the shaped body to which the support body is added as the object.

Next, the reception unit 562 waits until receiving an operation via the operation reception image (step S130).

When it is determined that the operation is received via the operation reception image (YES in step S130), the reception unit 562 determines whether to end the input of the information in the operation reception image to the data generation device 50 (step S140). Here, in step S140, for example, when the operation received in step S130 is an operation indicating that the input is ended, the reception unit 562 determines to end the input of information in the operation reception image to the data generation device 50. On the other hand, in step S140, for example, when the operation received in step S130 is an operation different from the operation indicating that the input is ended, the reception unit 562 determines not to end the input of information in the operation reception image to the data generation device 50.

When the reception unit 562 determines not to end the input of information in the operation reception image to the data generation device 50 (NO in step S140), each of the display control unit 561 and the generation unit 563 performs processing according to the operation received in step S130 (step S150). The processing is, for example, processing of receiving information such as the slice condition information, the shaping path generation condition information, and the correspondence information, processing of causing the generation unit 563 to generate the object data, or the like, and is not limited thereto. After the processing of step S150 is performed, the reception unit 562 transitions to step S130 and waits again until the operation via the operation reception image is received.

In this way, the data generation device 50 receives the slice condition information, the shaping path generation condition information, and the correspondence information and generates the object data by the processing of steps S130 to S150.

On the other hand, when the reception unit 562 determines that the input of the information in the operation reception image to the data generation device 50 is ended (YES in step S140), the generation unit 563 slices the object indicated by the object data into the N slice layers VL based on the object data generated by the processing in steps S130 to S150 and the slice condition information received by the processing (step S160).

Next, the generation unit 563 sequentially selects the slice layers VL one by one among the N slice layers VL sliced in step S160 from the slice layer VL1, and repeats processing of step S180 for each selected slice layer VL (step S170).

The generation unit 563 generates, based on the slice condition information, the shaping path generation condition information, and the correspondence information received in the processing of steps S130 to S150, the shaping path of the slice layer VL selected in step S170 (step S180).

Here, the processing of step S180 will be described in detail.

Therefore, hereinafter, for convenience of description, the slice layer VL selected in step S170 is referred to as a second slice layer, and the slice layer VL located immediately below the second slice layer is referred to as a first slice layer.

When the first slice layer is the shaping layer and the second slice layer is the shaping layer, in step S180, the generation unit 563 generates a shaping path of the second slice layer such that a contact area between a shaping path of the first slice layer and the shaping path of the second slice layer increases. In this case, the correspondence information includes information in which information indicating the shaping layer which is a type of the first slice layer, information indicating the shaping layer which is a type of the second slice layer, and first shaping path generation condition information are associated with one another. The first shaping path generation condition information is an example of information indicating a condition for generating the shaping path of the second slice layer, and is information indicating that the shaping path of the second slice layer is generated such that the contact area between the shaping path of the first slice layer and the shaping path of the second slice layer increases.

The contact area between the shaping path of the first slice layer and the shaping path of the second slice layer is proportional to a contact area between the slice layer L corresponding to the first slice layer and the slice layer L corresponding to the second slice layer. Therefore, the increase in the contact area between the shaping path of the first slice layer and the shaping path of the second slice layer means an increase in an interlayer strength between the slice layer L corresponding to the first slice layer and the slice layer L corresponding to the second slice layer. Further, the contact area between the shaping path of the first slice layer and the shaping path of the second slice layer changes according to, for example, a degree of overlap between the shaping path of the first slice layer and the shaping path of the second slice layer. More specifically, the contact area increases as the degree of overlap increases. On the other hand, the contact area decreases as the degree of overlap decreases. Further, the degree of overlap is determined according to a direction of the shaping path of the first slice layer and a direction of the shaping path of the second slice layer. Therefore, generation of the shaping path of the second slice layer such that the contact area between the shaping path of the first slice layer and the shaping path of the second slice layer increases can be implemented, for example, by adjusting the direction of the shaping path of the second slice layer with respect to the direction of the shaping path of the first slice layer.

Here, a direction of a shaping path of a certain slice layer VL is defined at each position on the shaping path. In addition, the direction of the certain shaping path at a certain position is defined as a direction in which the nozzle Nz is moved to a next position from a certain position. For example, when a direction in which the nozzle Nz located at a position X1 among positions on the shaping path is moved to a next position X2 is a positive direction of the X axis, a direction of the shaping path at the position X1 is a direction facing the positive direction of the X axis.

The degree of overlap between the shaping path of the first slice layer and the shaping path of the second slice layer increases as the directions of the two shaping paths come close to parallel with each other at one or more overlapping positions where the shaping path of the first slice layer and the shaping path of the second slice layer overlap with each other. On the other hand, the degree of overlap between the shaping path of the first slice layer and the shaping path of the second slice layer decreases as the directions of the two shaping paths come close to orthogonal to each other at one or more overlapping positions where the shaping path of the first slice layer and the shaping path of the second slice layer overlap with each other.

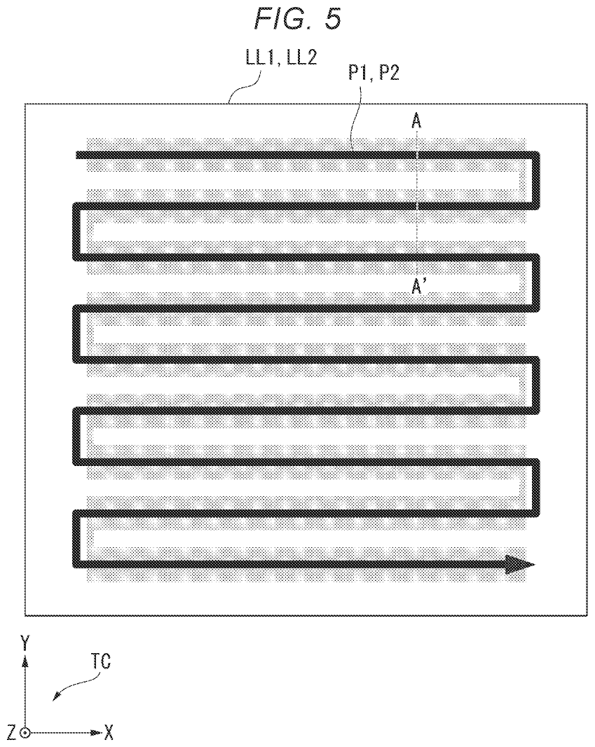

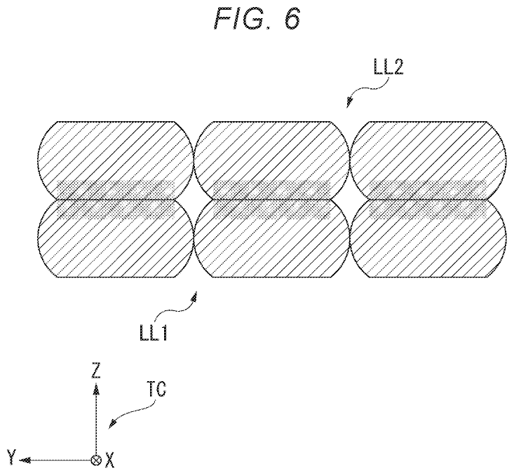

FIG. 5 is a view showing an example of a contact area between a first slice layer LL1 and a second slice layer LL2 when a shaping path P1 of the first slice layer LL1 and a shaping path P2 of the second slice layer LL2 stacked on the first slice layer LL1 completely overlap with each other in a vertical direction. An arrow shown in FIG. 5 indicates the shaping path P1 and the shaping path P2 that completely overlap with each other in the vertical direction. That is, each of the shaping path P1 and the shaping path P2 extends along the arrow from a start point of the arrow toward an end point of the arrow. FIG. 6 shows an example of a cross-sectional view when the first slice layer LL1 and the second slice layer LL2 are cut along a line A-A′ shown in FIG. 5. In FIGS. 5 and 6, a region hatched with dots indicates a region where the first slice layer LL1 and the second slice layer LL2 are in contact with each other. An area of a plane parallel to an XY plane among planes of the region indicates the contact area between the first slice layer LL1 and the second slice layer LL2. As shown in FIGS. 5 and 6, when the shaping path P1 and the shaping path P2 completely overlap with each other in the vertical direction, that is, when the first slice layer LL1 and the second slice layer LL2 overlap with each other such that the direction of the shaping path P1 and the direction of the shaping path P2 are parallel to each other at each position on the shaping path P1, the region where the first slice layer LL1 and the second slice layer LL2 are in contact with each other extends along two shaping paths including the shaping path P1 and the shaping path P2. Therefore, in this case, the degree of overlap of the shaping paths between the first slice layer LL1 and the second slice layer LL2 is maximized. As a result, in this case, as shown in FIGS. 5 and 6, the contact area between the first slice layer LL1 and the second slice layer LL2 is maximized.

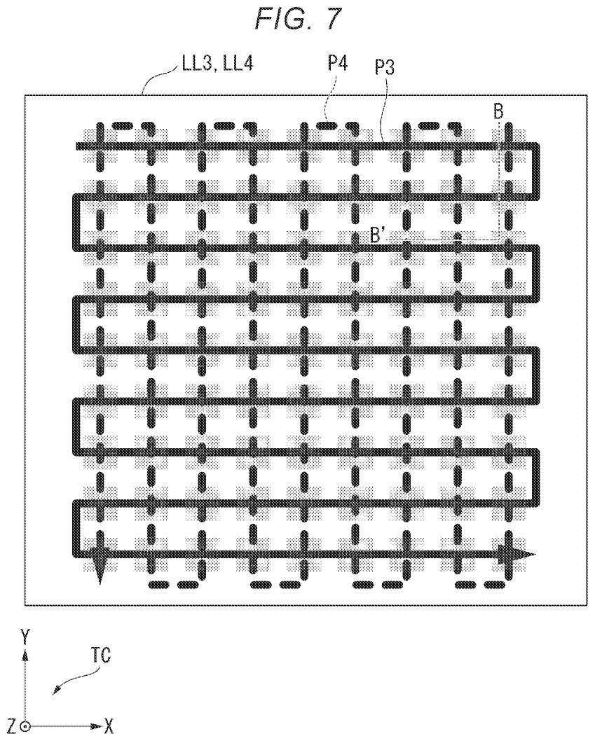

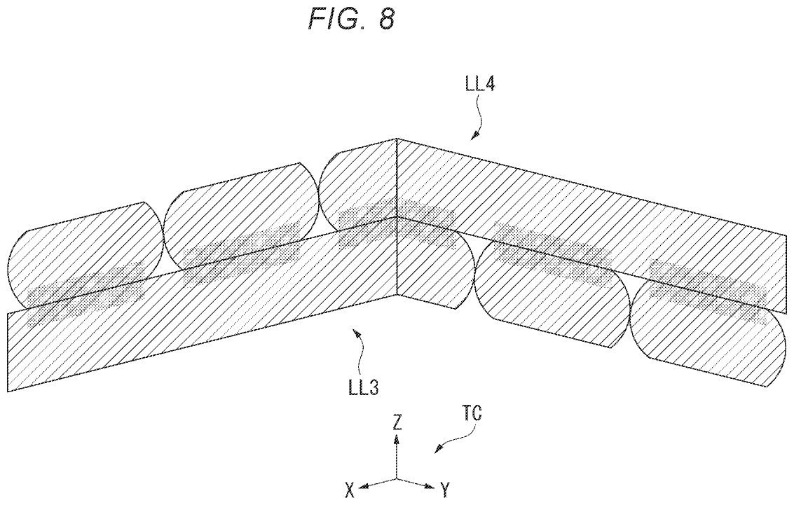

On the other hand, FIG. 7 is a view showing an example of a contact area between a first slice layer LL3 and a second slice layer LL4 when a shaping path P3 of the certain first slice layer LL3 and a shaping path P4 of the second slice layer LL4 stacked on the first slice layer LL3 do not substantially overlap with each other in the vertical direction. A solid arrow shown in FIG. 7 indicates the shaping path P3. That is, the shaping path P3 extends along the arrow from a start point of the arrow toward an end point of the arrow. A dotted-line arrow shown in FIG. 7 indicates the shaping path P4. That is, the shaping path P4 extends along the arrow from a start point of the arrow toward an end point of the arrow. FIG. 8 is a view showing an example of a cross-sectional view when the first slice layer LL3 and the second slice layer LL4 are cut along a line B-B′ shown in FIG. 7. The shaping path P3 and the shaping path P4 are orthogonal to each other at a plurality of overlapping positions where the shaping path P3 and the shaping path P4 overlap with each other. In FIGS. 7 and 8, regions hatched with dots indicate regions where the first slice layer LL3 and the second slice layer LL4 are in contact with each other. An area of planes parallel to the XY plane among planes in the regions indicates a contact area between the first slice layer LL3 and the second slice layer LL4. As shown in FIGS. 7 and 8, when the shaping path P3 and the shaping path P4 are orthogonal to each other at the plurality of overlapping positions, the regions where the first slice layer LL3 and the second slice layer LL4 are in contact with each other are scattered at the plurality of overlapping positions. Therefore, in this case, the degree of overlap of the shaping paths between the first slice layer LL3 and the second slice layer LL4 is minimized. As a result, in this case, as shown in FIGS. 7 and 8, the contact area between the first slice layer LL3 and the second slice layer LL4 is minimized.

In this way, generation of the shaping path of the second slice layer such that the contact area between the shaping path of the first slice layer and the shaping path of the second slice layer increases can be implemented by, for example, adjusting the direction of the shaping path of the second slice layer with respect to the direction of the shaping path of the first slice layer. Therefore, when the first slice layer is the shaping layer and the second slice layer is the shaping layer, in step S180, the generation unit 563 generates the shaping path of the second slice layer, for example, such that the directions of the two shaping paths come close to parallel with each other at one or more overlapping positions where the shaping path of the first slice layer and the shaping path of the second slice layer overlap with each other. Accordingly, in this case, the generation unit 563 can generate the shaping path of the second slice layer such that the contact area between the shaping path of the first slice layer and the shaping path of the second slice layer increases. As a result, the data generation device 50 can generate the three-dimensional shaping data capable of increasing the interlayer strength between the shaping layers. That is, the three-dimensional shaping apparatus 1 can increase the interlayer strength between the shaping layers.

When the first slice layer is the shaping layer and the second slice layer is the shaping layer, the generation unit 563 can also generate the shaping path of the second slice layer such that the contact area between the shaping path of the first slice layer and the shaping path of the second slice layer increases by slowing the moving speed of the nozzle Nz when the shaping material X is discharged along the shaping path of the second slice layer. This is because a volume of the shaping material X discharged from the tip end of the nozzle Nz per unit time increases as the moving speed of the nozzle Nz decreases.

When the first slice layer is the shaping layer and the second slice layer is the shaping layer, the generation unit 563 can also generate the shaping path of the second slice layer such that the contact area between the shaping path of the first slice layer and the shaping path of the second slice layer increases by increasing a width of the shaping path of the second slice layer.

When the first slice layer is the solid layer and the second slice layer is the solid layer, in step S180, the generation unit 563 generates the shaping path of the second slice layer such that the direction of the shaping path of the first slice layer and the direction of the shaping path of the second slice layer intersect with each other at one or more overlapping positions where the shaping path of the first slice layer and the shaping path of the second slice layer overlap with each other. In this case, for example, in step S180, the generation unit 563 generates the shaping path of the second slice layer such that the direction of the shaping path of the first slice layer and the direction of the shaping path of the second slice layer are orthogonal to each other for each of the one or more overlapping positions. In these cases, the correspondence information includes information in which information indicating the solid layer which is the type of the first slice layer, information indicating the solid layer which is the type of the second slice layer, and second shaping path generation condition information are associated with one another. The second shaping path generation condition information is information indicating that the shaping path of the second slice layer is generated such that the direction of the shaping path of the first slice layer and the direction of the shaping path of the second slice layer intersect with each other at one or more overlapping positions where the shaping path of the first slice layer and the shaping path of the second slice layer overlap with each other. In this case, the data generation device 50 can generate the three-dimensional shaping data capable of preventing deterioration of an aesthetic appearance of the three-dimensional shaped object due to shading of the shaping material X being seen in the solid layer. That is, the three-dimensional shaping apparatus 1 can prevent the deterioration of the aesthetic appearance of the three-dimensional shaped object due to the shading of the shaping material X being seen in the solid layer.

Further, when the first slice layer is the raft layer and the second slice layer is the raft layer, in step S180, the generation unit 563 generates the shaping path of the second slice layer such that the contact area between the shaping path of the first slice layer and the shaping path of the second slice layer increases. In this case, the correspondence information includes information in which information indicating the raft layer which is the type of the first slice layer, information indicating the raft layer which is the type of the second slice layer, and the first shaping path generation condition information described above are associated with one another.

Accordingly, the data generation device 50 can generate the three-dimensional shaping data capable of increasing the interlayer strength between the raft layers. That is, the three-dimensional shaping apparatus 1 can increase the interlayer strength between the raft layers.

Further, when the first slice layer is the support layer and the second slice layer is the support layer, in step S180, the generation unit 563 generates the shaping path of the second slice layer such that the contact area between the shaping path of the first slice layer and the shaping path of the second slice layer increases. In this case, the correspondence information includes information in which information indicating the support layer which is the type of the first slice layer, information indicating the support layer which is the type of the second slice layer, and the first shaping path generation condition information described above are associated with one another. Accordingly, the data generation device 50 can generate the three-dimensional shaping data capable of increasing an interlayer strength between the support layers. That is, the three-dimensional shaping apparatus 1 can increase the interlayer strength between the support layers.

When the first slice layer is the solid layer and the second slice layer is the shaping layer, in step S180, the generation unit 563 generates the shaping path of the second slice layer such that the contact area between the shaping path of the first slice layer and the shaping path of the second slice layer increases. In this case, the correspondence information includes information in which the information indicating the solid layer which is the type of the first slice layer, the information indicating the shaping layer which is the type of the second slice layer, and the first shaping path generation condition information described above are associated with one another. Accordingly, the data generation device 50 can generate the three-dimensional shaping data capable of increasing an interlayer strength between the first solid layer and the shaping layer. That is, the three-dimensional shaping apparatus 1 can increase the interlayer strength between the first solid layer and the shaping layer.

When the first slice layer is the raft layer and the second slice layer is the solid layer, in step S180, the generation unit 563 generates the shaping path of the second slice layer such that the contact area between the shaping path of the first slice layer and the shaping path of the second slice layer decreases. In this case, the correspondence information includes information in which the information indicating the raft layer which is the type of the first slice layer, the information indicating the solid layer which is the type of the second slice layer, and third shaping path generation condition information are associated with one another. The third shaping path generation condition information is an example of the information indicating the condition for generating the shaping path of the second slice layer, and is information indicating that the shaping path of the second slice layer is generated such that the contact area between the shaping path of the first slice layer and the shaping path of the second slice layer decreases. Here, in this case, in step S180, for example, the generation unit 563 generates the shaping path of the second slice layer such that the directions of the two shaping paths come close to orthogonal to each other at one or more overlapping positions where the shaping path of the first slice layer and the shaping path of the second slice layer overlap with each other. Accordingly, in this case, the generation unit 563 can generate the shaping path of the second slice layer such that the contact area between the shaping path of the first slice layer and the shaping path of the second slice layer decreases. As a result, the data generation device 50 can generate the three-dimensional shaping data capable of reducing an interlayer strength between the raft layer and the first solid layer. In other words, the data generation device 50 can generate the three-dimensional shaping data for easily removing the raft layer from the shaped body without the sintering step. Further, that is, the three-dimensional shaping apparatus 1 can reduce the interlayer strength between the raft layer and the first solid layer. In other words, the three-dimensional shaping apparatus 1 can easily remove the raft layer from the shaped body without the sintering step.

When the first slice layer is the raft layer and the second slice layer is the solid layer, the generation unit 563 can also generate the shaping path of the second slice layer such that the contact area between the shaping path of the first slice layer and the shaping path of the second slice layer decreases by increasing the moving speed of the nozzle Nz when the shaping material X is discharged along the shaping path of the second slice layer. This is because the volume of the shaping material X discharged from the tip end of the nozzle Nz per unit time decreases as the moving speed of the nozzle Nz increases.

When the first slice layer is the raft layer and the second slice layer is the solid layer, the generation unit 563 can also generate the shaping path of the second slice layer such that the contact area between the shaping path of the first slice layer and the shaping path of the second slice layer decreases by reducing the width of the shaping path of the second slice layer.

When the first slice layer is the support layer and the second slice layer is the solid layer, in step S180, the generation unit 563 generates the shaping path of the second slice layer such that the contact area between the shaping path of the first slice layer and the shaping path of the second slice layer decreases. In this case, the correspondence information includes information in which the information indicating the support layer that is the type of the first slice layer, the information indicating the solid layer that is the type of the second slice layer, and the above-described third shaping path generation condition information are associated with one another. Accordingly, in this case, the generation unit 563 can generate the shaping path of the second slice layer such that the contact area between the shaping path of the first slice layer and the shaping path of the second slice layer decreases. As a result, the data generation device 50 can generate the three-dimensional shaping data capable of reducing an interlayer strength between the support layer and the first solid layer. In other words, the data generation device 50 can generate the three-dimensional shaping data for easily removing the support body from the shaped body without the sintering step. That is, the three-dimensional shaping apparatus 1 can reduce the interlayer strength between the support layer and the first solid layer. In other words, the three-dimensional shaping apparatus 1 can easily remove the support body from the shaped body without the sintering step.

After the processing of step S180 is performed, the generation unit 563 selects the current second slice layer as the next first slice layer, and then proceeds to step S170 to select the next slice layer VL as the second slice layer. When there is no unselected slice layer VL in step S170, the generation unit 563 ends the repetitive processing of steps S170 to S180.

After the repetitive processing of steps S170 and S180 is performed, the generation unit 563 generates the above-described three-dimensional shaping data based on the shaping path of each of the N slice layers VL generated by the repetitive processing (step S190).

Next, the generation unit 563 outputs the three-dimensional shaping data generated in step S190 to the control device 40 (step S200), and causes the control device 40 to store the three-dimensional shaping data.

Next, the generation unit 563 stores the three-dimensional shaping data generated in step S190 in the storage unit 52 (step S210), and ends the processing of a flowchart shown in FIG. 4.

In this way, when generating the shaping path of the second slice layer in step S180, the data generation device 50 generates the shaping path of the second slice layer based on the correspondence information, the type of the first slice layer, and the type of the second slice layer. Accordingly, the data generation device 50 can generate the three-dimensional shaping data for easily removing the raft layer and the support body from the shaped body without the sintering step.

In step S160, that is, when the object is sliced into the N slice layers VL, if an eleventh slice layer located on a lower side of two slice layers VL overlapping with each other in the vertical direction is the solid layer and a twelfth slice layer located on an upper side of the two slice layers VL is the shaping layer, the generation unit 563 may be configured to make a thickness of the twelfth slice layer larger than a thickness of each of the plurality of solid layers including the eleventh slice layer. In this case, for example, the generation unit 563 reduces the thickness of each of the plurality of solid layers including the eleventh slice layer by an amount corresponding to an increase in the thickness of the twelfth slice layer. Accordingly, the data generation device 50 can increase a formation speed of the shaping layer, and as a result, shaping efficiency of the three-dimensional shaped object can be improved.

In step S160, that is, when the object is sliced into the N slice layers VL, if the eleventh slice layer located on the lower side of the two slice layers VL overlapping with each other in the vertical direction is the shaping layer and the twelfth slice layer located on the upper side of the two slice layers VL is the solid layer, the generation unit 563 may be configured to make the thickness of the twelfth slice layer smaller than an average value of the thicknesses of the plurality of shaping layers including the eleventh slice layer. In this case, for example, the generation unit 563 increases the thickness of each of the plurality of shaping layers including the eleventh slice layer by an amount corresponding to a decrease in the thickness of the twelfth slice layer. Accordingly, the data generation device 50 can reduce transmittance of light at a place where the shaping paths are in contact with each other, and as a result, the deterioration of the aesthetic appearance of the three-dimensional shaped object can be prevented.

In step S180, when two types of layers of the solid layer and the shaping layer are included in the certain slice layer VL, the generation unit 563 may be configured to generate the shaping path such that the outline indicating a boundary between the solid layer and the shaping layer is included in the shaping path of the slice layer VL. Accordingly, the data generation device 50 can generate the three-dimensional shaping data capable of preventing occurrence of curling of the solid layer at the boundary between the solid layer and the shaping layer in the slice layer L corresponding to the slice layer VL. That is, the three-dimensional shaping apparatus 1 can prevent the occurrence of curling of the solid layer at the boundary between the solid layer and the shaping layer in the slice layer L corresponding to the slice layer VL.

Processing in which Control Device Causes Three-Dimensional Shaping Apparatus to Shape Three-Dimensional Shaped Object

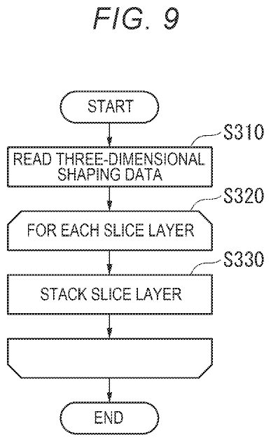

Hereinafter, processing in which the control device 40 causes the three-dimensional shaping apparatus 1 to shape the three-dimensional shaped object will be described with reference to FIG. 9. FIG. 9 is a diagram showing an example of a flow of the processing in which the control device 40 causes the three-dimensional shaping apparatus 1 to shape the three-dimensional shaped object. Hereinafter, for example, a case will be described where the three-dimensional shaping data generated by the processing of the flowchart shown in FIG. 4 is stored in the memory of the control device 40 at a timing before processing of step S310 shown in FIG. 9 is performed. Hereinafter, for example, a case where the control device 40 receives a shaping start operation for starting the processing at the timing will be described.

After receiving the shaping start operation, the three-dimensional shaping apparatus control unit 41 reads the three-dimensional shaping data stored in advance in the memory of the control device 40 from the memory (step S310).

Next, based on the three-dimensional shaping data read in step S310, the three-dimensional shaping apparatus control unit 41 sequentially selects the slice layers VL one by one among the N slice layers VL from the slice layer VL1, and repeats the processing of step S330 for each selected slice layer VL (step S320).

The three-dimensional shaping apparatus control unit 41 causes the shaping material X to be discharged along the shaping path of the slice layer VL selected in step S320, and stacks the slice layer L corresponding to the slice layer VL (step S330). Accordingly, for example, when the slice layer VL is set as a fourth slice layer and the slice layer VL located immediately below the slice layer VL is set as a third slice layer, and the third slice layer is the shaping layer and the fourth slice layer is the shaping layer, the three-dimensional shaping apparatus control unit 41 can stack the fourth slice layer on the third slice layer such that a contact area with a shaping path of the fourth slice layer increases. That is, in this case, the three-dimensional shaping apparatus 1 can increase the interlayer strength between the shaping layers.

For example, when the third slice layer is the solid layer and the fourth slice layer is the solid layer, the three-dimensional shaping apparatus control unit 41 can stack the fourth slice layer on the third slice layer such that a direction of a shaping path of the third slice layer and a direction of the shaping path of the fourth slice layer intersect with each other at one or more overlapping positions where the shaping path of the third slice layer and the shaping path of the fourth slice layer overlap with each other. That is, in this case, the three-dimensional shaping apparatus 1 can prevent the deterioration of the aesthetic appearance of the three-dimensional shaped object due to the shading of the shaping material X being seen in the solid layer.

For example, when the third slice layer is the raft layer and the fourth slice layer is the raft layer, the three-dimensional shaping apparatus control unit 41 can stack the fourth slice layer on the third slice layer such that the contact area with the shaping path of the fourth slice layer increases. That is, in this case, the three-dimensional shaping apparatus 1 can increase the interlayer strength between the raft layers.

For example, when the third slice layer is the support layer and the fourth slice layer is the support layer, the three-dimensional shaping apparatus control unit 41 can stack the fourth slice layer on the third slice layer such that the contact area with the shaping path of the fourth slice layer increases. That is, in this case, the three-dimensional shaping apparatus 1 can increase the interlayer strength between the support layers.

For example, when the third slice layer is the solid layer and the fourth slice layer is the shaping layer, the three-dimensional shaping apparatus control unit 41 can stack the fourth slice layer on the third slice layer such that the contact area with the shaping path of the fourth slice layer increases. That is, in this case, the three-dimensional shaping apparatus 1 can increase the interlayer strength between the solid layer and the shaping layer.

For example, when the third slice layer is the raft layer and the fourth slice layer is the solid layer, the three-dimensional shaping apparatus control unit 41 can stack the fourth slice layer on the third slice layer such that the contact area with the shaping path of the fourth slice layer decreases. That is, in this case, the three-dimensional shaping apparatus 1 can reduce the interlayer strength between the raft layer and the solid layer. In other words, the three-dimensional shaping apparatus 1 can easily remove the raft layer from the shaped body without the sintering step.

In addition, for example, when the third slice layer is the support layer and the fourth slice layer is the solid layer, the three-dimensional shaping apparatus control unit 41 can stack the fourth slice layer on the third slice layer such that the contact area with the shaping path of the fourth slice layer decreases. That is, in this case, the three-dimensional shaping apparatus 1 can reduce the interlayer strength between the support layer and the solid layer. In other words, the three-dimensional shaping apparatus 1 can easily remove the support body from the shaped body without the sintering step.

After the processing of step S330 is performed, the three-dimensional shaping apparatus control unit 41 proceeds to step S320 and selects the next slice layer VL. When there is no unselected slice layer VL in step S320, the three-dimensional shaping apparatus control unit 41 ends repetitive processing of steps S320 to S330 and ends the processing of a flowchart shown in FIG. 9.

The contents described above may be combined in any manner.

As described above, an information processing apparatus according to the embodiment is an information processing apparatus that generates three-dimensional shaping data for causing a plurality of slice layers to be stacked as a three-dimensional shaped object having a predetermined shape in a three-dimensional shaping apparatus. The information processing apparatus includes: a storage unit configured to store object data indicating an object including at least a shaped body of the shaped body and a support body, the shaped body having the shape of the three-dimensional shaped object, the support body supporting the shaped body; and a generation unit configured to virtually slice, based on slice condition information indicating a slice condition for virtually slicing the object indicated by the object data into the plurality of slice layers, the object into the plurality of slice layers, generate, based on shaping path generation condition information indicating a shaping path generation condition for generating a shaping path of the plurality of slice layers individually, the shaping path of the individual slice layers of the plurality of slice layers obtained by the slicing, and generate the three-dimensional shaping data including shaping path information indicating the generated shaping path of the individual slice layers of the plurality of slice layers. The slice condition information includes first slice layer type information indicating a type of a first slice layer among the plurality of slice layers and second slice layer type information indicating a type of a second slice layer stacked on the first slice layer among the plurality of slice layers. The shaping path generation condition information includes correspondence information including information in which the type of the first slice layer, the type of the second slice layer, and information indicating a condition for generating a shaping path of the second slice layer are associated with one another. When generating the shaping path of the second slice layer, the generation unit generates the shaping path of the second slice layer based on the correspondence information, the type of the first slice layer, and the type of the second slice layer. Accordingly, the information processing apparatus can generate the three-dimensional shaping data for easily removing the raft layer and the support body from the shaped body without a sintering step. Here, in the example described above, the three-dimensional shaping apparatus 1 is an example of the three-dimensional shaping apparatus. In the example described above, the data generation device 50 is an example of the information processing apparatus. In the example described above, the storage unit 52 is an example of the storage unit. In the example described above, the N slice layers VL are an example of the plurality of slice layers. In the example described above, the generation unit 563 is an example of the generation unit. Further, in the example described above, a first solid layer, the shaping layer, a second solid layer, a support layer, and the raft layer are examples of a type of the first slice layer, and are also examples of a type of the second slice layer.

In the information processing apparatus, when the first slice layer is a shaping layer and the second slice layer is a shaping layer, the condition for generating the shaping path of the second slice layer may be to generate the shaping path of the second slice layer such that a contact area between a shaping path of the first slice layer and the shaping path of the second slice layer increases. When the first slice layer is the shaping layer and the second slice layer is the shaping layer, the generation unit may generate the shaping path of the second slice layer such that a contact area between the shaping path of the first slice layer and the shaping path of the second slice layer increases.

In the information processing apparatus, when the first slice layer is a solid layer and the second slice layer is a solid layer, the condition for generating the shaping path of the second slice layer may be to generate the shaping path of the second slice layer such that a direction of a shaping path of the first slice layer and a direction of the shaping path of the second slice layer intersect with each other at one or more overlapping positions where the shaping path of the first slice layer and the shaping path of the second slice layer overlap with each other. When the first slice layer is the solid layer and the second slice layer is the solid layer, the generation unit may generate the shaping path of the second slice layer such that the direction of the shaping path of the first slice layer and the direction of the shaping path of the second slice layer intersect with each other at the one or more overlapping positions where the shaping path of the first slice layer and the shaping path of the second slice layer overlap with each other.

In the information processing apparatus, when the first slice layer is a raft layer and the second slice layer is a raft layer, the condition for generating the shaping path of the second slice layer may be to generate the shaping path of the second slice layer such that a contact area between a shaping path of the first slice layer and the shaping path of the second slice layer increases. When the first slice layer is the raft layer and the second slice layer is the raft layer, the generation unit may generate the shaping path of the second slice layer such that the contact area between the shaping path of the first slice layer and the shaping path of the second slice layer increases.

In the information processing apparatus, when the first slice layer is a support layer and the second slice layer is a support layer, the condition for generating the shaping path of the second slice layer may be to generate the shaping path of the second slice layer such that a contact area between a shaping path of the first slice layer and the shaping path of the second slice layer increases. When the first slice layer is the support layer and the second slice layer is the support layer, the generation unit may generate the shaping path of the second slice layer such that the contact area between the shaping path of the first slice layer and the shaping path of the second slice layer increases.

In the information processing apparatus, when the first slice layer is a solid layer and the second slice layer is a shaping layer, the condition for generating the shaping path of the second slice layer may be to generate the shaping path of the second slice layer such that a contact area between a shaping path of the first slice layer and the shaping path of the second slice layer increases. When the first slice layer is the solid layer and the second slice layer is the shaping layer, the generation unit may generate the shaping path of the second slice layer such that the contact area between the shaping path of the first slice layer and the shaping path of the second slice layer increases.

In the information processing apparatus, when the object is sliced into the plurality of slice layers, and the first slice layer is a solid layer and the second slice layer is a shaping layer, the generation unit may make a thickness of the second slice layer larger than a thickness of individual solid layers of a plurality of solid layers including the first slice layer.

In the information processing apparatus, when the object is sliced into the plurality of slice layers, and the first slice layer is a shaping layer and the second slice layer is a solid layer, the generation unit may make a thickness of the second slice layer smaller than an average value of thicknesses of a plurality of shaping layers including the first slice layer.

In the information processing apparatus, when the first slice layer is a raft layer and the second slice layer is a solid layer, the condition for generating the shaping path of the second slice layer may be to generate the shaping path of the second slice layer such that a contact area between a shaping path of the first slice layer and the shaping path of the second slice layer decreases. When the first slice layer is the raft layer and the second slice layer is the solid layer, the generation unit may generate the shaping path of the second slice layer such that the contact area between the shaping path of the first slice layer and the shaping path of the second slice layer decreases.

In addition, in the information processing apparatus, when the first slice layer is a support layer and the second slice layer is a solid layer, the condition for generating the shaping path of the second slice layer may be to generate the shaping path of the second slice layer such that a contact area between a shaping path of the first slice layer and the shaping path of the second slice layer decreases. When the first slice layer is the support layer and the second slice layer is the solid layer, the generation unit may generate the shaping path of the second slice layer such that the contact area between the shaping path of the first slice layer and the shaping path of the second slice layer decreases.

A three-dimensional shaping apparatus according to the embodiment is a three-dimensional shaping apparatus including an information processing apparatus configured to generate three-dimensional shaping data for causing a plurality of slice layers to be stacked as a three-dimensional shaped object having a predetermined shape in the three-dimensional shaping apparatus. The information processing apparatus includes: a storage unit configured to store object data indicating an object including at least a shaped body of the shaped body and a support body, the shaped body having the shape of the three-dimensional shaped object, the support body supporting the shaped body; and a generation unit configured to virtually slice, based on slice condition information indicating a slice condition for virtually slicing the object indicated by the object data into the plurality of slice layers, the object into the plurality of slice layers, generate, based on shaping path generation condition information indicating a shaping path generation condition for generating a shaping path of the plurality of slice layers individually, the shaping path of the individual slice layers of the plurality of slice layers obtained by the slicing, and generate the three-dimensional shaping data including shaping path information indicating the generated shaping path of the individual slice layers of the plurality of slice layers. The slice condition information includes first slice layer type information indicating a type of a first slice layer among the plurality of slice layers and second slice layer type information indicating a type of a second slice layer stacked on the first slice layer among the plurality of slice layers. The shaping path generation condition information includes correspondence information including information in which the type of the first slice layer, the type of the second slice layer, and information indicating a condition for generating a shaping path of the second slice layer are associated with one another. When generating the shaping path of the second slice layer, the generation unit generates the shaping path of the second slice layer based on the correspondence information, the type of the first slice layer, and the type of the second slice layer. Accordingly, the three-dimensional shaping apparatus can generate the three-dimensional shaping data for easily removing the raft layer and the support body from the shaped body without a sintering step.

The embodiment according to the present disclosure has been described above in detail with reference to the drawings, but the specific configuration is not limited to the embodiment, and changes, substitutions, deletions, and the like may be made without departing from the gist of the present disclosure.

Further, a program for implementing functions of any component in the device described above may be recorded in a computer-readable recording medium, and the program may be read and executed by a computer system. Here, the device is, for example, the three-dimensional shaping apparatus 1, the control device 40, the data generation device 50, or the like. Here, the term “computer system” includes an operating system (OS) and hardware such as peripheral devices. The term “computer-readable recording medium” refers to a storage device such as a portable medium such as a flexible disk, a magneto-optical disk, an ROM, or a compact disc (CD)-ROM, or a hard disk incorporated in the computer system. Furthermore, the term “computer-readable recording medium” includes a medium that holds a program for a certain period of time, such as a volatile memory inside the computer system serving as a server or a client when the program is transmitted via a network such as the Internet or a communication line such as a telephone line.

The program may be transmitted from a computer system in which the program is stored in a storage device or the like to another computer system via a transmission medium or by transmission waves in the transmission medium. Here, the term “transmission medium” that transmits the program refers to a medium having a function of transmitting information, such as a network such as the Internet or a communication line such as a telephone line.

The program may be a program for implementing a part of the above-described functions. Further, the program may be a so-called differential file or differential program that can implement the above-described functions in combination with a program already recorded in the computer system.

What is claimed is:

1. An information processing apparatus that generates three-dimensional shaping data for causing a plurality of slice layers to be stacked as a three-dimensional shaped object having a predetermined shape in a three-dimensional shaping apparatus, the information processing apparatus comprising:
a storage unit configured to store object data indicating an object including at least a shaped body of the shaped body and a support body, the shaped body having the shape of the three-dimensional shaped object, the support body supporting the shaped body; and
a generation unit configured to
virtually slice, based on slice condition information indicating a slice condition for virtually slicing the object indicated by the object data into the plurality of slice layers, the object into the plurality of slice layers,
generate, based on shaping path generation condition information indicating a shaping path generation condition for generating a shaping path of the plurality of slice layers individually, the shaping path of the individual slice layers of the plurality of slice layers obtained by the slicing, and
generate the three-dimensional shaping data including shaping path information indicating the generated shaping path of the individual slice layers of the plurality of slice layers, wherein
the slice condition information includes first slice layer type information indicating a type of a first slice layer among the plurality of slice layers and second slice layer type information indicating a type of a second slice layer stacked on the first slice layer among the plurality of slice layers,
the shaping path generation condition information includes correspondence information including information in which the type of the first slice layer, the type of the second slice layer, and information indicating a condition for generating a shaping path of the second slice layer are associated with one another, and
when generating the shaping path of the second slice layer, the generation unit generates the shaping path of the second slice layer based on the correspondence information, the type of the first slice layer, and the type of the second slice layer.

2. The information processing apparatus according to claim 1, wherein
when the first slice layer is a shaping layer and the second slice layer is a shaping layer, the condition for generating the shaping path of the second slice layer is to generate the shaping path of the second slice layer such that a contact area between a shaping path of the first slice layer and the shaping path of the second slice layer increases, and
when the first slice layer is the shaping layer and the second slice layer is the shaping layer, the generation unit generates the shaping path of the second slice layer such that the contact area between the shaping path of the first slice layer and the shaping path of the second slice layer increases.

3. The information processing apparatus according to claim 1, wherein
when the first slice layer is a solid layer and the second slice layer is a solid layer, the condition for generating the shaping path of the second slice layer is to generate the shaping path of the second slice layer such that a direction of a shaping path of the first slice layer and a direction of the shaping path of the second slice layer intersect with each other at one or more overlapping positions where the shaping path of the first slice layer and the shaping path of the second slice layer overlap with each other, and
when the first slice layer is the solid layer and the second slice layer is the solid layer, the generation unit generates the shaping path of the second slice layer such that the direction of the shaping path of the first slice layer and the direction of the shaping path of the second slice layer intersect with each other at the one or more overlapping positions where the shaping path of the first slice layer and the shaping path of the second slice layer overlap with each other.

4. The information processing apparatus according to claim 1, wherein
when the first slice layer is a raft layer and the second slice layer is a raft layer, the condition for generating the shaping path of the second slice layer is to generate the shaping path of the second slice layer such that a contact area between a shaping path of the first slice layer and the shaping path of the second slice layer increases, and
when the first slice layer is the raft layer and the second slice layer is the raft layer, the generation unit generates the shaping path of the second slice layer such that the contact area between the shaping path of the first slice layer and the shaping path of the second slice layer increases.

5. The information processing apparatus according to claim 1, wherein
when the first slice layer is a support layer and the second slice layer is a support layer, the condition for generating the shaping path of the second slice layer is to generate the shaping path of the second slice layer such that a contact area between a shaping path of the first slice layer and the shaping path of the second slice layer increases, and
when the first slice layer is the support layer and the second slice layer is the support layer, the generation unit generates the shaping path of the second slice layer such that the contact area between the shaping path of the first slice layer and the shaping path of the second slice layer increases.

6. The information processing apparatus according to claim 1, wherein
when the first slice layer is a solid layer and the second slice layer is a shaping layer, the condition for generating the shaping path of the second slice layer is to generate the shaping path of the second slice layer such that a contact area between a shaping path of the first slice layer and the shaping path of the second slice layer increases, and
when the first slice layer is the solid layer and the second slice layer is the shaping layer, the generation unit generates the shaping path of the second slice layer such that the contact area between the shaping path of the first slice layer and the shaping path of the second slice layer increases.

7. The information processing apparatus according to claim 1, wherein
when the object is sliced into the plurality of slice layers, and the first slice layer is a solid layer and the second slice layer is a shaping layer, the generation unit makes a thickness of the second slice layer larger than a thickness of individual solid layers of a plurality of solid layers including the first slice layer.

8. The information processing apparatus according to claim 1, wherein
when the object is sliced into the plurality of slice layers, and the first slice layer is a shaping layer and the second slice layer is a solid layer, the generation unit makes a thickness of the second slice layer smaller than an average value of thicknesses of a plurality of shaping layers including the first slice layer.

9. The information processing apparatus according to claim 1, wherein
when the first slice layer is a raft layer and the second slice layer is a solid layer, the condition for generating the shaping path of the second slice layer is to generate the shaping path of the second slice layer such that a contact area between a shaping path of the first slice layer and the shaping path of the second slice layer decreases, and
when the first slice layer is the raft layer and the second slice layer is the solid layer, the generation unit generates the shaping path of the second slice layer such that the contact area between the shaping path of the first slice layer and the shaping path of the second slice layer decreases.

10. The information processing apparatus according to claim 1, wherein
when the first slice layer is a support layer and the second slice layer is a solid layer, the condition for generating the shaping path of the second slice layer is to generate the shaping path of the second slice layer such that a contact area between a shaping path of the first slice layer and the shaping path of the second slice layer decreases, and
when the first slice layer is the support layer and the second slice layer is the solid layer, the generation unit generates the shaping path of the second slice layer such that the contact area between the shaping path of the first slice layer and the shaping path of the second slice layer decreases.

11. A three-dimensional shaping apparatus comprising:
an information processing apparatus configured to generate three-dimensional shaping data for causing a plurality of slice layers to be stacked as a three-dimensional shaped object having a predetermined shape in the three-dimensional shaping apparatus, wherein
the information processing apparatus includes:
a storage unit configured to store object data indicating an object including at least a shaped body of the shaped body and a support body, the shaped body having the shape of the three-dimensional shaped object, the support body supporting the shaped body; and
a generation unit configured to
virtually slice, based on slice condition information indicating a slice condition for virtually slicing the object indicated by the object data into the plurality of slice layers, the object into the plurality of slice layers,
generate, based on shaping path generation condition information indicating a shaping path generation condition for generating a shaping path of the plurality of slice layers individually, the shaping path of the individual slice layers of the plurality of slice layers obtained by the slicing, and
generate the three-dimensional shaping data including shaping path information indicating the generated shaping path of the individual slice layers of the plurality of slice layers,
the slice condition information includes first slice layer type information indicating a type of a first slice layer among the plurality of slice layers and second slice layer type information indicating a type of a second slice layer stacked on the first slice layer among the plurality of slice layers,
the shaping path generation condition information includes correspondence information including information in which the type of the first slice layer, the type of the second slice layer, and information indicating a condition for generating a shaping path of the second slice layer are associated with one another, and
when generating the shaping path of the second slice layer, the generation unit generates the shaping path of the second slice layer based on the correspondence information, the type of the first slice layer, and the type of the second slice layer.
